(19) United States
(12) Patent Application Publication
(10) Pub. No.: US 2007/0127195 A1
(43) Pub. Date: Jun. 7, 2007

(54) The Laptop Doorway

(75) Inventor: Bobbie Lee King JR., Princeton, NJ (US)

Correspondence Address: Bobbie Lee King Jr., F 1056 Frist Campus Center, Princeton University, Princeton, NJ, 08544, US

(73) Assignee: Bobbie Lee King JR., Princeton, NJ (US)

(21) Appl. No.: 11/164,849

(22) Filed: Dec. 7, 2005

(51) Int. Cl. G06F 1/16

(52) U.S. Cl. 361/681

(57) ABSTRACT

The invention in a response to the problems associated with limited screen space of portable computing devices (i.e. laptops). Because of issues of portability, size and weight these devices have been limited to a single, undersized screen in which relatively small amounts of information can be displayed at the same time. Though there exists some means of attaching secondary displays to the devices, there exists no practical way of taking these secondary screens with the user. The invention rests on the premise of creating a new system that allows for the portability of secondary display devices. By placing a secondary screen on a hinge in front of the primary screen, while still maintaining the portability of the original portable computing device I solve this issue. The concept resembles the concept similar to a door. Thus, the secondary screen(s) shall be known as the “door screen(s)” and the primary screen shall be known as the “doorway screen”.

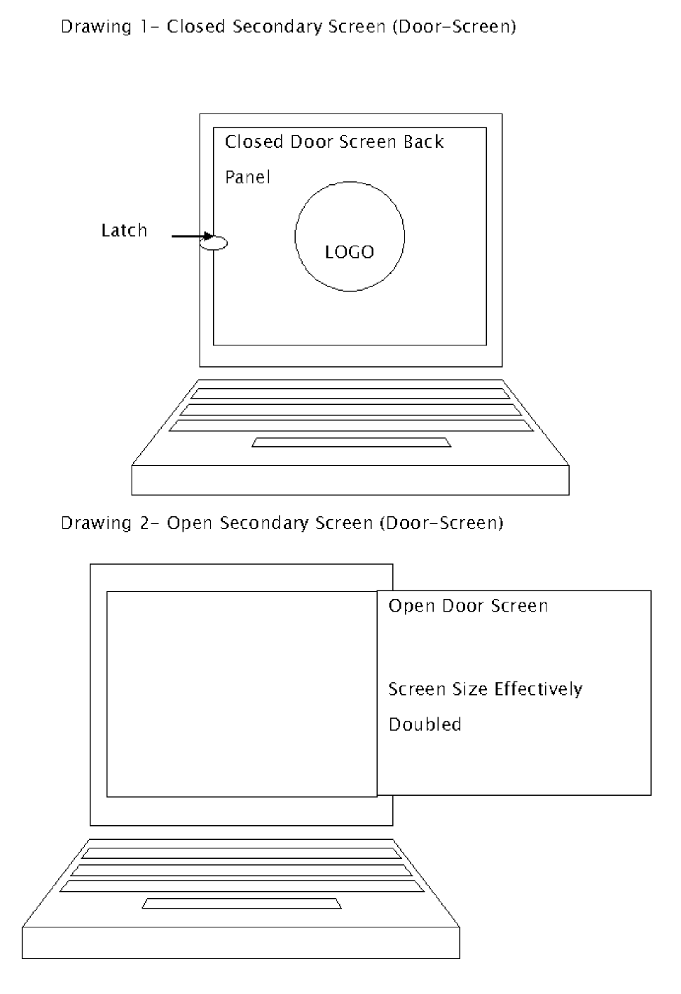

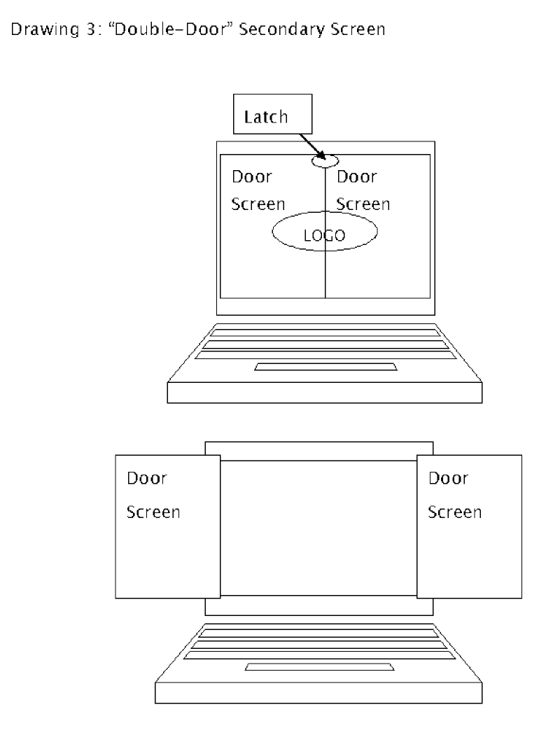

### DESCRIPTION

The screen is encased in a lightweight metal or durable plastic and loaded in a thin but recognizable docking bay behind the primary screen. It is connected to the central processing unit by cables or wirelessly within the docking bay which are not visible to the user. The device, when docked, is loaded such that the release of a switch or button or other apparatus will release the screen from the docking bay and allow the user to expose the screen so that it may act as a secondary screen to the primary screen.

The screen may activate manually or automatically depending on the preferences of the users and the software available to them. Once the user has completed using the door screen(s), he may close them or simply deactivate the screen(s). Upon completion of his use of the computer, he can return the secondary screen(s) to the closed position and close the device as he would with any other portable computing device. When closed it (they) can latch itself (themselves) automatically or be latched manually by the user. Once again, the screen(s) may either shut down automatically, or manually, depending on the preference of the user.

The modifications to the existing portable computing devices would only be to add some thickness to the casing for the standard screen and add a latch in order to secure the secondary screen(s) when in the closed position. The thickness to the casing would be to make room for the secondary screen. The secondary screen, itself, is a standard portable computing device screen with some modification in size. The screen's wiring will also me modified so that it can be efficiently connected to the computing device. The best mode of operation seems to be similar to the typical laptop hinge, in which the connector is located within the hinge of the laptop. The true innovation of the device is the addition of the secondary screen using the doorway principles.

What is claimed is:

1. My claim is to the invention of any device or modification that extends the standard screen of the portable computing device using the doorway method. The idea to have a secondary screen or to have multiple screens open (much like a doorway) and act as extensions to the standard primary screen of a portable computing device is my own. This idea is limited to permanently-attached secondary screen devices for the portable computing devices.
